(19) United States
(12) Patent Application Publication
(10) Pub. No.: US 2010/0105013 A1
(43) Pub. Date: Apr. 29, 2010

(54) String dispenser having an adhesive therein

(76) Inventors: Jim McCafferty, San Clemente, CA (US); Greg Leong, Irvine, CA (US); Steven Douglas DeLacy, Santa Ana, CA (US)

Correspondence Address: TOPE-MCKAY & ASSOCIATES, 23852 PACIFIC COAST HIGHWAY #311, MALIBU, CA, 90265, US

(21) Appl. No.: 12/587,700

(22) Filed: Oct. 10, 2009

Related U.S. Application Data
(60) Provisional application No. 61/195,765, filed on Oct. 10, 2008.

(51) Int. Cl. B65H 49/00; B23P 11/00; B65D 83/00

(52) U.S. Cl. 434/83; 29/428; 242/588.3

(57) ABSTRACT

A string dispenser kit is described. The string dispenser kit includes a string dispenser and a peg board. The string dispenser is formed as a string pen having a string storing element, an elongated barrel, and a tip element. The string pen is formed to store string and dispense string through the elongated barrel and from the tip element of the string dispenser. An adhesive substance is contained in the elongated barrel to douse the string. The peg board has a first plate with pegs and a second plate with corresponding holes. The second plate is formed to be positioned over the first plate. Once the string is positioned over the pegs in a desired form and the adhesive substance is dry, the second plate can be removed from the first plate to pull the string from the pegs and maintain the string in the desired form.

### PRIORITY CLAIM

The present application is a Non-Provisional patent application of U.S. Provisional Application No. 61/195,765, filed in the United States on Oct. 10, 2008, titled, “String Dispenser and Peg Board.”

### BACKGROUND OF THE INVENTION

(1) Field of Invention

The present invention relates to a string dispenser and, more particularly, to a string dispenser having an adhesive therein that applies adhesive to the string upon dispensing of the string.

(2) Description of Related Art

String looms, or peg boards, used for forming designs in string have long been known in the art. Typically, a user first arranges multiple pegs within holes of the string loom to form a desired shape or design. Then, string or a string-like material (e.g., rubber band) is wound around the arranged pegs so that the string forms the desired shape or design. While operable for initially forming the desired shapes or designs, existing devices do not allow a user to preserve the shape or design. Once the pegs are released from the string loom or the string is removed from the pegs, the string is unwound and resumes its original shape.

Thus, a continuing need exists for a string dispenser which allows a user to form a shape or design that retains its form once the string is removed from a string loom or peg board.

### SUMMARY OF INVENTION

The present invention relates to a string dispenser kit including an elongated barrel with a first end and a second end. A string storing element is connected with the first end of the elongated barrel, and a tip element is positioned at the second end of the elongated barrel. A string is positioned in the string storing element, wherein the string is dispensed from the string storing element, through the elongated barrel, and out of the tip element.

In another aspect, an adhesive material is stored within the elongated barrel, such that the string dispensed through the elongated barrel is coated with the adhesive material as it exits the tip element.

In another aspect, a fluid retention device is positioned proximate the tip element to retain the adhesive material in the elongated barrel.

In yet another aspect, a spool is positioned within the string storing element, such that the string is wound around the spool in the string storing element.

In another aspect, the string dispenser kit further comprises a peg board including a first plate and a second plate. The first plate includes a plurality of pegs, and the second plate comprises a plurality of holes positioned to correspond to the plurality of pegs. The second plate is formed to be removably positioned on top of the first plate, such that the plurality of pegs from the first plate pass through the plurality of holes in the second plate, thereby forming the peg board. A user can dispense the string from the string dispenser around the plurality of pegs of the peg board to form a shape with the string.

In another aspect, the string dispenser kit further comprises an adhesive material stored within the elongated barrel, such that the string dispensed through the elongated barrel is coated with the adhesive material as it exits the tip element. When a shape is formed with the string around the plurality of pegs of the peg board, the adhesive material dries and irreversibly retains the shape formed with the string.

In another aspect, the string dispenser kit further comprises a storage case for storing the string pen and peg board.

In yet another aspect, the string dispenser kit further comprises a fan attached with the storage case, such that the fan is positioned proximate the peg board to blow air upon the peg board to dry the adhesive material on the string.

Finally, as can be appreciated by one in the art, the present invention also comprises a method for forming and using the string dispenser kit described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1A is an illustration of a string dispenser according to the present invention;

FIG. 1B is an illustration of a front, cross-sectional view of a string dispenser according to the present invention;

FIG. 1C is an illustration of a side, cross-sectional view of a string dispenser according to the present invention;

FIG. 2A is an illustration of a top-view of a first plate of a peg board according to the present invention;

FIG. 2B is an illustration of a top-view of a second plate of a peg board according to the present invention;

FIG. 2C is an illustration of a top-view of an assembled peg board according to the present invention;

FIG. 2D is an illustration of a side-view of a first plate of a peg board according to the present invention;

FIG. 2E is an illustration of a side-view of a second plate of a peg board according to the present invention;

FIG. 2F is an illustration of a side-view of an assembled peg board according to the present invention; and

FIG. 3 is an illustration of a string dispenser kit including a string dispenser and assembled peg board according to the present invention.

### DETAILED DESCRIPTION

The present invention relates to a string dispenser and, more particularly, to a string dispenser having an adhesive therein that applies adhesive to the string upon dispensing of the string. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

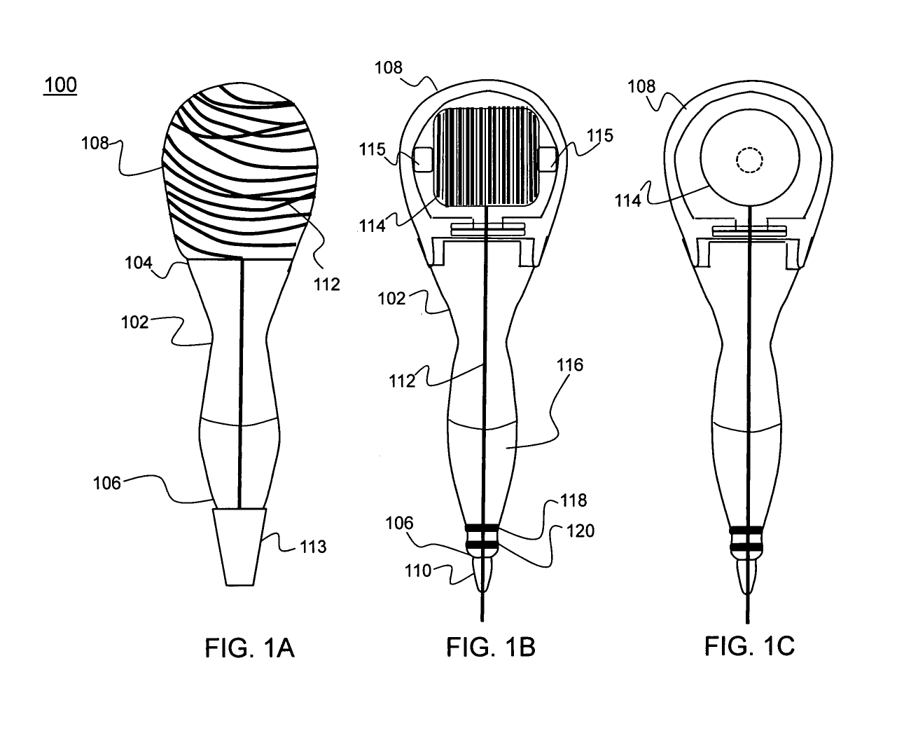

The present invention relates to a string dispenser having an adhesive stored inside the dispenser, such that the adhesive is applied to the string as the string is dispensed. The string dispenser may be utilized for forming shapes or designs from the string, which retain their structure after the string is wound around pegs of a string loom or peg board due to the drying of the adhesive. In a desired aspect and as illustrated in FIGS. 1A-1C, the string dispenser 100 is formed as a pen. The string dispenser 100 includes an elongated barrel 102 having a first end 104 and a second end 106. A hollow string storing element 108 is connected with the first end 104 of the elongated barrel 102. The string storing element 108 is screwed onto the elongated barrel 102 and sealed with either heat or adhesive to prevent it from being separated from the elongated barrel 102. Alternatively, the string storing element 108 is integrally formed with the elongated barrel 102. The string storing element 108 is formed to store a string 112 (or a thread) therein. Furthermore, the string storing element 108 can be enclosed to encase the string 112 therein, or open to allow a user to view the string 112. A removable cap 113 covers a tip element 110 positioned at the second end 106 of the elongated barrel 102. The string 112 is positioned in the string storing element 108, such that the string 112 is dispensed from the string storing element 108, through the elongated barrel 102, and out of the tip element 110.

FIG. 1B illustrates a front-view, cross-section of the string dispenser 100. In a desired aspect and as shown, the string storing element 108 encloses a spool 114 of string 112 therein. The string storing element 108 includes a set of spool retaining elements 115 on opposite sides which secure the spool 114 inside the string storing element 108. The string 112 from the spool 114 is thread through the elongated barrel 102 and out of the tip element 110. Included in the elongated barrel 102 is an adhesive substance 116, a non-limiting example of which includes glue. Thus, as the string 112 is thread through the elongated barrel 102 and out of the tip element 110, the string 112 is doused in or otherwise exposed to the adhesive substance 116.

To prevent the adhesive substance 116 from draining out of the tip element 110 of the string dispenser 100, any suitable fluid retention device is used. As a non-limiting example, a first rubber gasket 118 and a second rubber gasket 120 are used. The first 118 and second 120 rubber gaskets include holes therein, through which the string 112 passes. The holes are of such size and the rubber gaskets 118 and 120 are of such elasticity that they form a seal around the string 112 to prevent the adhesive substance 116 from draining from the elongated barrel 102.

FIG. 1C illustrates a side-view, cross-section of the string dispenser 100. The side-view illustration provides an alternative view of the spool 114 encased within the string storing element 108.

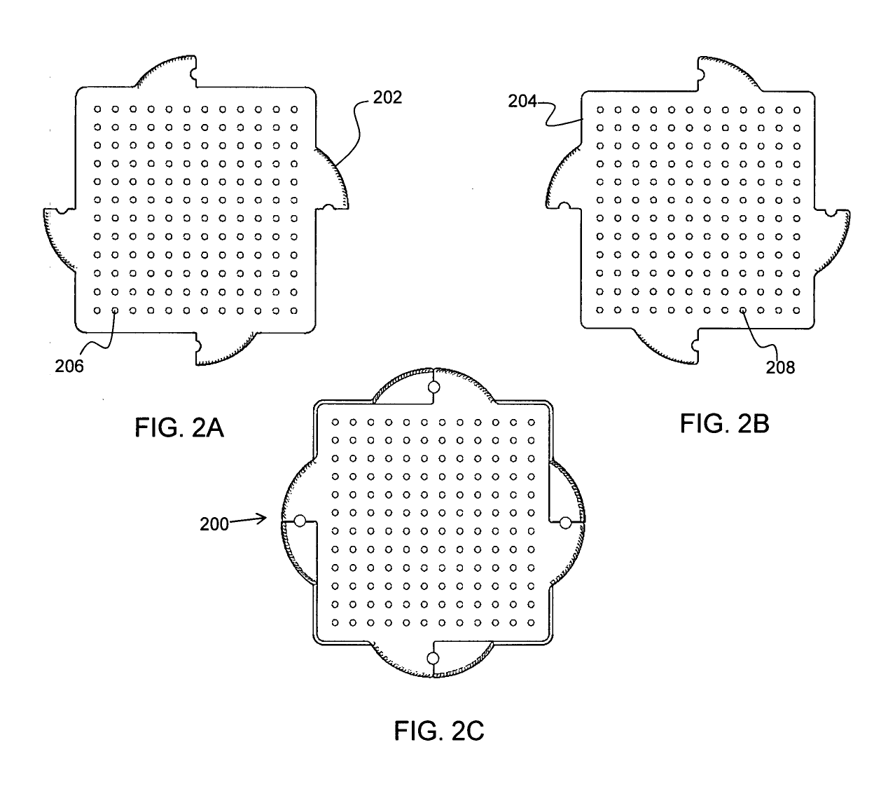

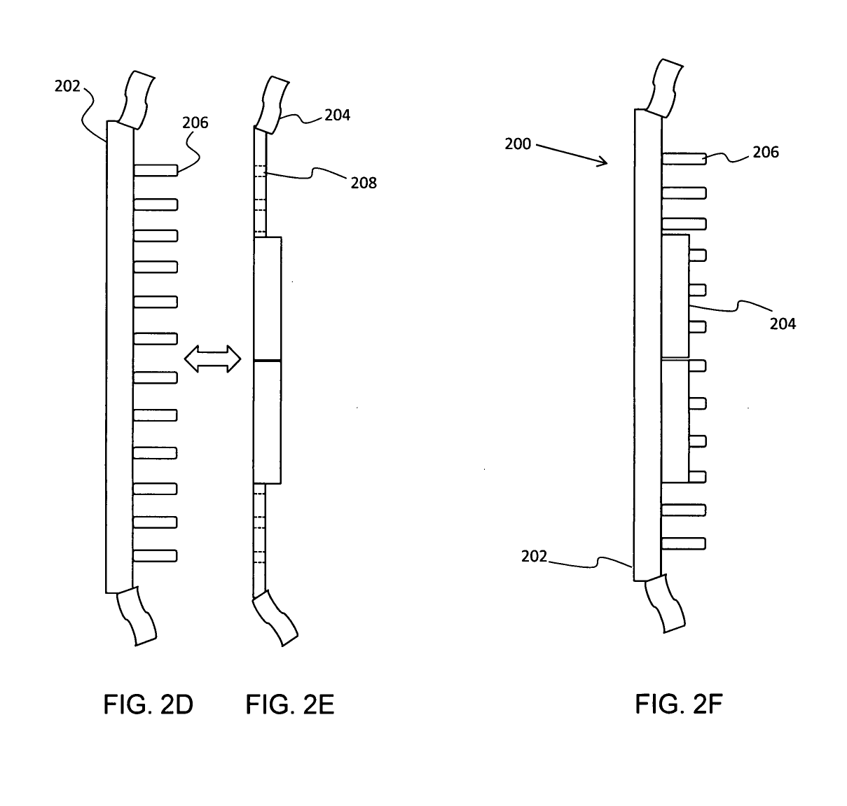

As shown in FIG. 2A, the present invention includes a string dispenser kit which includes a peg board 200 having a first plate 202 and a second plate 204. The first plate 202 includes a plurality of pegs 206. The pegs 206 are formed with or permanently affixed to the first plate 202. In another aspect, the pegs 206 may be removably attachable with holes in the first plate 202.

As shown in FIG. 2B, the second plate 204 includes a plurality of holes 208 that correspond to the pegs 206 of the first plate 202. The second plate 204 is formed to be removably positioned over the first plate 204, with the pegs 206 from the first plate 202 passing through the holes 208 in the second plate 204. As shown in FIG. 2C, once the peg board 200 is assembled (i.e., the first plate 202 affixed with the second plate 204), the assembled peg board 200 is ready for use by a user.

For further illustration, FIGS. 2D through 2F illustrate side views of the peg board 200. As shown in FIG. 2D, the first plate 202 includes a plurality of pegs 206. The second plate 204, illustrated in FIG. 2E, is formed to be removably positioned on top of the first plate 202 such that the pegs 206 pass through the holes 208 of the second plate 204. Finally, FIG. 2F illustrates the assembled peg board 200 with the pegs 206 protruding from the first plate 202 through the second plate 204.

As noted above, the present invention is for use with a device or devices upon which the string dispenser can be used to dispense the string. For example, the string dispenser 100 illustrated in FIGS. 1A through 1C can be used with the peg board 200 of FIGS. 2A through 2F. The string 112 from the string dispenser 100 can be dispensed and wrapped around the pegs 206 in any desirable pattern. To dispense the string 112, a user first pulls the string 112 from the tip element 110 and ties it to the peg board 200, or any suitable stationary device. String 112 is dispensed from the tip element 110 as the string dispenser 100 is pulled away from the peg board 200. After a desired pattern is created with the string 112, the end of the string 112 is cut with a pair of scissors, or the like. The adhesive substance 116 thereafter dries and affixes the string 112 into the desired pattern. Once positioned on the pegs 204 and affixed in the desired pattern, the second plate 204 can be lifted up and removed from the first plate 202, thereby effectively lifting the string 112 from the pegs 206. Although the string 112 is removed from the pegs 206, the string 112 retains its shape in the desired pattern due to the use of the adhesive substance 116.

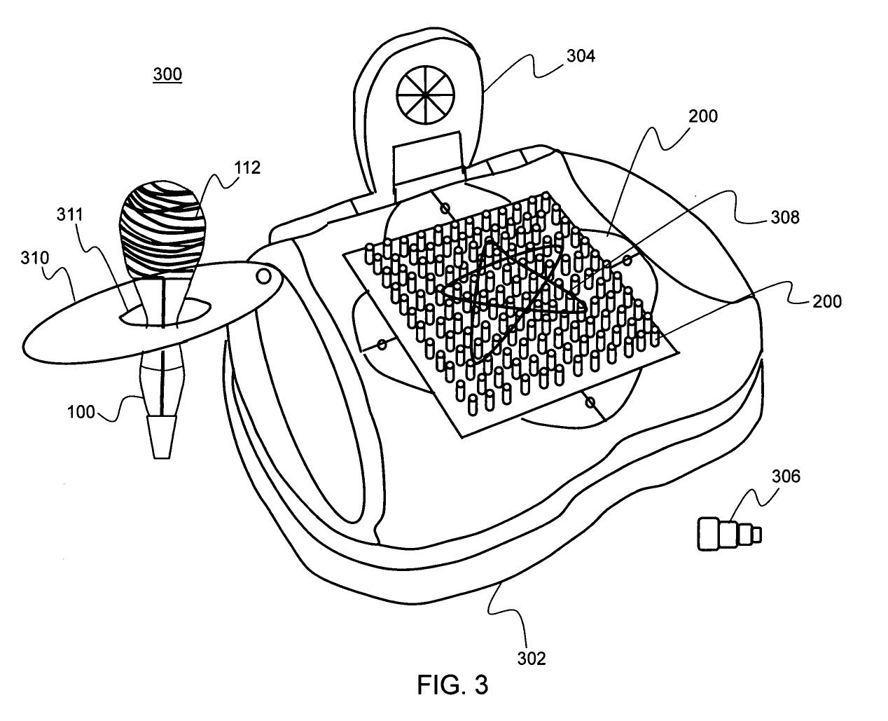

FIG. 3 provides an illustration of the present invention as a string dispenser kit 300 with a variety of components for use with the string dispenser 100. The string dispenser kit 200 can include a storage case 302 to store items such as the string dispenser 100, a fan 304, and a ring form 306 (among any other suitable items). The ring form 306 is similar to a jewelers ring sizing stick in that it expands conically or stepwise to fit varying ring sizes. In the present invention, the ring form 306 is used to allow a user to wrap the string 112 from the string dispenser 100 around the ring form 306. After the adhesive substance is dry, the user can remove the string 112 from the ring form 306, thereby forming a custom, string-made, ring.

As shown, the peg board 200 can be positioned on the storage case 302 to allow a user to use the string dispenser 100 to wrap string 112 around the pegs 206 of the peg board 200 to form a desirable string design 308. Once the string design 308 is completed, the fan 304, which is positioned proximate the peg board 200, can be used to blow air across the string design 308, thereby assisting the adhesive substance in drying to affix the string 112 into the string design 308. The fan 304 can be detachably attached with the storage case 302 or be folded down into the storage case 302 when not in use. Additionally, the storage case 302 may include a string dispenser holder 310 with a hole 311 therein which is pivotally attached with the storage case 302 to hold the string dispenser 100. A set of design stencils (not shown) which can be placed under the peg board 200 may also be included with the string dispenser kit 300 so that users can follow the lines of the stencil to create more complicated string designs. Finally, the string dispenser kit 300 may include a variety of accessories, non-limited examples of which include jewels, charms, and stickers, which can be used to decorate the string designs.

What is claimed is:

1. A string dispenser kit, comprising:
an elongated barrel having a first end and a second end;
a string storing element connected with the first end of the elongated barrel;
a tip element positioned at the second end of the elongated barrel; and
a string positioned in the string storing element, wherein the string is dispensed from the string storing element, through the elongated barrel, and out of the tip element.

2. A string dispenser kit as set forth in claim 1, further comprising an adhesive material stored within the elongated barrel, such that the string dispensed through the elongated barrel is coated with the adhesive material as it exits the tip element.

3. A string dispenser kit set forth in claim 2, further comprising a fluid retention device positioned proximate the tip element to retain the adhesive material in the elongated barrel.

4. A string dispenser kit as set forth in claim 3, further comprising a spool positioned within the string storing element, such that the string is wound around the spool in the string storing element.

5. A string dispenser kit as set forth in claim 4, further comprising:
a peg board comprising a first plate and a second plate;
wherein the first plate comprises a plurality of pegs and the second plate comprises a plurality of holes positioned to correspond to the plurality of pegs;
wherein the second plate is formed to be removably positioned on top of the first plate, such that the plurality of pegs from the first plate pass through the plurality of holes in the second plate, thereby forming the peg board;
wherein a user can dispense the string from the string dispenser around the plurality of pegs of the peg board to form a shape with the string.

6. A string dispenser kit as set forth in claim 5, wherein the string dispenser further comprises an adhesive material stored within the elongated barrel, such that the string dispensed through the elongated barrel is coated with the adhesive material as it exits the tip element, wherein when a shape is formed with the string around the plurality of pegs of the peg board, the adhesive material dries and irreversibly retains the shape formed with the string.

7. A string dispenser kit as set forth in claim 6, further comprising a storage case for storing the string pen and peg board.

8. A string dispenser kit as set forth in claim 7, further comprising a fan attached with the storage case, such that the fan is positioned proximate the peg board to blow air upon the peg board to dry the adhesive material on the string.

9. A method for forming a string dispenser kit, comprising acts of:
forming an elongated barrel having a first end and a second end;
connecting a string storing element with the first end of the elongated barrel;
forming a tip element at the second end of the elongated barrel; and
positioning a string in the string storing element, wherein the string is dispensed from the string storing element, through the elongated barrel, and out of the tip element.

10. A method for forming a string dispenser kit as set forth in claim 9, further comprising an act of storing an adhesive material within the elongated barrel, such that the string dispensed through the elongated barrel is coated with the adhesive material as it exits the tip element.

11. A method for forming a string dispenser kit set forth in claim 10, further comprising an act of positioning a fluid retention device proximate the tip element to retain the adhesive material in the elongated barrel.

12. A method for forming string dispenser kit as set forth in claim 11, further comprising an act of positioning a spool within the string storing element, such that the string is wound around the spool in the string storing element.

13. A method for forming a string dispenser kit as set forth in claim 12, further comprising acts of:
forming a peg board comprising a first plate and a second plate;
wherein the first plate comprises a plurality of pegs and the second plate comprises a plurality of holes positioned to correspond to the plurality of pegs;
wherein the second plate is formed to be removably positioned on top of the first plate, such that the plurality of pegs from the first plate pass through the plurality of holes in the second plate, thereby forming the peg board;
wherein a user can dispense the string from the string dispenser around the plurality of pegs of the peg board to form a shape with the string.

14. A method for forming a string dispenser kit as set forth in claim 13, further comprising an act of storing an adhesive material within the elongated barrel, such that the string dispensed through the elongated barrel is coated with the adhesive material as it exits the tip element, wherein when a shape is formed with the string around the plurality of pegs of the peg board, the adhesive material dries and irreversibly retains the shape formed with the string.

15. A method for forming a string dispenser kit as set forth in claim 14, further comprising an act of forming a storage case for storing the string pen and peg board.

16. A method for forming a string dispenser kit as set forth in claim 15, further comprising an act of attaching a fan with the storage case, such that the fan is positioned proximate the peg board to blow air upon the peg board to dry the adhesive material on the string.
